(19) United States
(12) Patent Application Publication
(10) Pub. No.: US 2005/0081093 A1
(43) Pub. Date: Apr. 14, 2005

(54) Ternary content addressable memory directed associative redundancy for semiconductor memories

(76) Inventors: Craig Shannon Joly, Edmonton (CA); Duncan George Elliott, Edmonton (CA)

Correspondence Address: Duncan Elliott;Department of Electrical and Computer Engineering, Electrical and Computer Engineering Res. Facility, University of Alberta, Edmonton, AB, T6G 2V4, CA

(21) Appl. No.: 10/949,358

(22) Filed: Sep. 27, 2004

Related U.S. Application Data
(60) Provisional application No. 60/506,953, filed on Sep. 29, 2003.

(51) Int. Cl. G06F 11/00

(52) U.S. Cl. 714/8

(57) ABSTRACT

A method for a redundancy mechanism to increase defect and fault tolerance in semiconductor memories, such as DRAM, is disclosed. The repair of single cell, row, column or cluster faults is achieved by accessing a list of faulty regions in parallel with the main memory. This list of faulty regions uses a three-state storage device to allow groups of faulty memory locations to be marked with a single entry. This mechanism is designed to be fully transparent to the semiconductor memory, allowing full regular operation, no reduction in frequency, increase in area over conventional row and column redundancy or extra fabrication steps.

This application claims priority from U.S. Application No. 60/506,953 filed Sep. 29, 2003.

### FIELD OF THE INVENTION

The preset invention relates to Very Large Scale Integrated (VLSI) circuit memories. In particular, the present invention relates to semiconductor memory redundancy systems.

### BACKGROUND OF THE INVENTION

High density memories such as dynamic random access memories (DRAM) and other types of semiconductor memories must be operating at 100% of their specified capacity in order to be sold. With millions of storage cells in a single memory, this is a difficult undertaking. In order to lower the number of nearly perfect memories that will be thrown out and to raise yields, memory manufacturers employ redundancy and, occasionally, error correction.

Redundancy has been used in DRAM designs since the 256-Kbit generation to improve yield by providing spare components that can be used to replace faulty ones. In the case of semiconductor memories, redundancy means providing rows and columns of extra memory cells on the die that can be electrically swapped for bad ones. Redundancy increases access and cycle times, power dissipation, IC area and requires design modifications. These downsides are justified because redundancy reduces the cost per bit in large capacity memories, increases the memory bit capacity in immature processes and aids in providing fully functional parts in low volume productions.

Redundancy is achieved by having extra columns and rows of memory cells on the die. Originally, if a row or column was not 100% operational, it could be swapped out by way of a selection mechanism, such as a laser-blown fuse. In the abstract, the laser acts as, and can be replaced by, a non-volatile programmable memory. As feature sizes shrunk, the size of conventional fuses became prohibitively large. They could not be sufficiently shrunk and still enable a laser to be focused on them. This led to redundant sections of rows or columns, usually all rows or columns attached to one address decoder, still controlled by fuses. Fuses have their own reliability problems. Openings blown by lasers in the passivation layer can cause moisture contamination, relocation of blown fuse material can cause stresses in other layers of the die and partially blown fuses can cause poor reliability. An alternative is to use programmable non-volatile memory in place of fuses.

Error correction employs redundancy of a different type. It is usually employed to reduce the effects of soft errors, however, it can be used to eliminate the effects of a single faulty cell (hard error) in a memory word. A word is the smallest addressable quanta of data in a memory. When a word is written to the memory, check bits are calculated and stored along with it. The check bits can be as simple as a parity code, which can detect, but not repair, a single bit error in the stored word, however, more often it is a Hamming code. The most common type of Hamming code in semiconductor memories can detect two bit errors and correct a single bit error.

All error correcting codes work by recalculating the check bits when the word is read from the memory array. The newly calculated check bits are compared with the stored check bits, usually by taking the bitwise XOR and syndrome bits are obtained. The syndrome bits may indicate whether an error has occurred and possibly where.

Associative redundancy methods operate by accessing a content addressable memory (CAM) in parallel with the memory array. A CAM is a memory array that compares incoming data with data stored in the array. The CAM along with a data array is referred to as an “associative memory,” as shown in FIG. 1. An associative memory determines its addressing based on already stored data, rather than an address location. The CAM array 1 compares incoming data 5 with all of its entries in parallel. If a match is found, the word-line in the data array 2 corresponding to the matching entry 3 in the CAM array is activated. The data array operates identically to a conventional random access memory, however, the word-lines are controlled by the compare array instead of address decoders 4.

In associative redundancy methods, if an incoming address points to a memory location that contains a fault, the faulty address is matched in the CAM and the data from the associated data array is placed onto the data pins in place of data from the regular memory array.

The basic operation of prior art associative repair is shown in FIG. 2. An incoming memory address 10 is sent to the CAM 8 and the main memory 7 in parallel. If the CAM 8 matches 11 an address 10, it may shut off (depending on the implementation) access to the main memory 7 while the secondary memory 9 is accessed.

There are three main items of prior art in associative redundancy methods. The first is an iterative approach where the memory array is split into equal size blocks. If a block contains a fault, any memory accesses within that block are redirected to another memory. The incoming address bits that correspond to the block are replaced with bits that address an equal sized block in the redundant memory. This redundant memory can also be split into smaller blocks that are replaced, and so forth. The CAM array contains the bits of the address corresponding to the block that has a fault while the associated data array contains the bits addressing the new block in the redundant memory array. The second approach stores the entire faulty memory address in the CAM and the memory word to be accessed in the associated data array. The third follows the main idea of the full address in the CAM array and the replaced memory word in the associated data but explores the possibility of using cache memory mappings.

Row and column redundancy offers efficient replacement when memory rows or columns fail, but suffer from having to replace many perfectly good memory locations when a single memory cell or cluster of cell fail. Error correction is efficient for single location failures and arguably for column failures. It cannot deal with situations where there is more than one failing location in a codeword. A codeword is a grouping of memory cells along a row containing data and calculated check bits for error correcting coding. The first associative repair prior art is efficient if a large number of failures occur in a block. The second two require a CAM entry for every single memory word containing a failure.

These redundancy methods are limited in that they can only replace fixed block-sizes and areas. It is, therefore, desirable to provide a redundancy mechanism that can efficiently handle all four failure situations (single cell, row, column and cluster), replacing the minimum number of good cells as possible, while minimizing the number of entries required in a list of bad memory locations, such as a CAM.

### SUMMARY OF THE INVENTION

An object of this invention is to provide a method for replacing arbitrarily-shaped groupings of faulty memory locations in a semiconductor memory with a single entry in a list of faulty locations.

It is a further object of this invention to increase fabrication yield and early fabrication yield ramp with no modifications to the fabrication process, no increase in area and not impact operating frequency or functionality of the semiconductor memory.

It is a further object of this invention to allow high speed memory operations such as page mode and double-data rate (DDR) operation in dynamic random access memories (DDR).

### BRIEF DESCRIPTION OF THE DRAWINGS

Embodiments of the present invention will now be described, by way of example only, with reference to the attached Figures, wherein:

FIG. 1 is a block diagram showing associative memory elements;

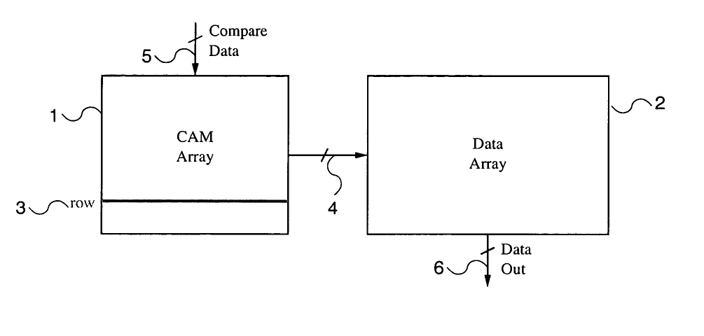

FIG. 2 is a block diagram showing basic operation of prior-art associated redundancy methods;

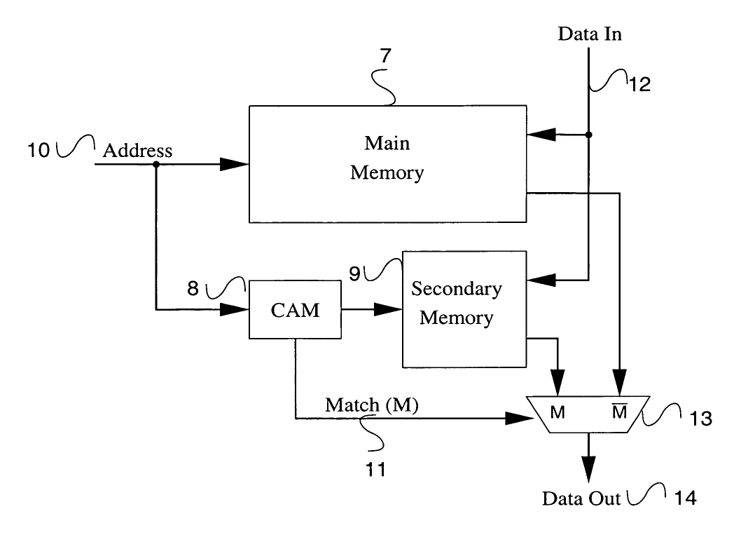

FIG. 3 is a block diagram of a ternary content addressable memory associative redundancy method according to an embodiment of the present invention;

FIG. 4 is a block diagram of an alternative ternary content addressable memory associative redundancy method according to an embodiment of the present invention;

FIG. 5 is a block diagram showing a matching device split into two components.

### DETAILED DESCRIPTION OF THE INVENTION

A method for replacing arbitrarily-shaped groupings of faulty memory locations in a semiconductor memory with a single entry in a list of faulty locations is disclosed. Replacement of non-fixed-size groupings of faulty memory locations is achieved by the use of a three-state storage device, such as a ternary content addressable memory (TCAM). A TCAM operates like a regular two-level CAM, but can also store a don't care value. If a TCAM cell contains a don't care, it will return a match for either compared value.

The redundancy methods presented can be incorporated into solid state or semiconductor memory chips and reduce area occupied by redundancy circuitry while maintaining acceptable yield in fabrication or improve yield without increasing chip area devoted to redundant circuitry. These methods can also be incorporated into a system comprised of multiple memory chips. One application of this wold be highly available computer systems that require online repair of defects that might arise or be detected. Another application is an inexpensive memory system comprised of partially functioning chips with the described redundancy method used to repair all defects and provide the functionality of a fully functional memory. Other forms of storage such as rotating storage or non-memories could also benefit from this redundancy method.

According to the embodiments of the present invention, the words in the main memory are addressed using Gray code for each of the row and column portions of the address. Gray code is a binary code in which consecutive decimal numbers are represented by binary numbers that differ in the state of a single bit (also Synonym reflected code). Gray code addressing can be achieved by re-ordering the lines output from the row and column decoders. The entire address is not Gray code, but a set of two Gray code values for the row and column components. The Gray code property of having only a single bit differing between adjacent values ensures that any area that is two words wide (2 cells along a column or the cell-width of two words along a row) can be marked with a single TCAM entry using a don't care. Larger areas may be marked using more don't care bits.

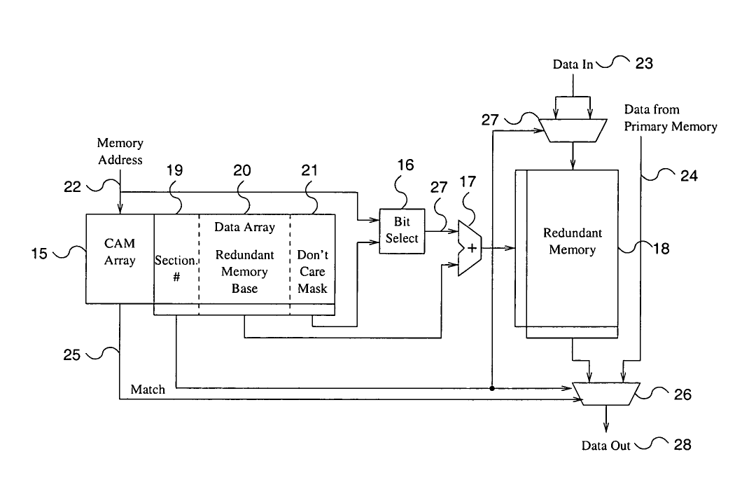

FIG. 3 is a block diagram illustrating a TCAM-based associative redundancy method for a semiconductor memory according to a present embodiment of the invention. This redundant path is composed of an associative memory, a bit-selector 16, an adder 17, a redundant memory 18 and several multiplexers 26,27. The associative memory consists of a TCAM array 15 and an associated two-level storage array 19,20,21.

The entire associative memory is non-volatile or loaded from non-volatile storage and programmed based on manufacturing test data. The TCAM 15 contains addresses of faulty cells in the main memory. Whenever possible, don't care bits are used to reduce the number of TCAM entries. The associated two-level storage array contains two or three values. The first is an optional section number 19. Modern DRAMs tend to split the storage of memory words into multiple sections. The section number allow only faulty sub-words to be stored, instead of the entire memory word, reducing memory requirements. This introduces the restriction that, unless there is a full or partial redundant path for each section, all parts of a word cannot be replaced. Multiplexer 23 is only required if the section number is used.

The second value in the associated storage data is a base memory address 20 for the redundant memory. The third value is a mask of the don't care bits 21. For every ‘0’ or ‘1’ value stored in the TCAM, the mask will contain the value ‘0.’ For every don't care value in the TCAM, the mask will contain the value ‘1.’

The bit selector 16 extracts the bits marked as don't care from an incoming memory address 22 to create an offset 27. It does this by logically ANDing the don't care mask 21 with the incoming address 22, then moving the masked bits to the lowest significant bits. For example, assume that the address 011100 is sent to a DRAM employing TCAM redundancy. This address matches with an entry in the TCAM containing 01X1X0. The mask value of 001010 is sent to the bit-selector which outputs an offset of 000010. The least significant ‘10’ are the input address bits corresponding to the two don't care bits in the mask.

The adder 17 adds the produced offset 27 with the base address 20 stored in the associated storage array. This produces the address of the replaced word in the redundant memory 18. The adder may be a simple bit-wise OR because the TCAM programmer has full control of where in the secondary memory, redundant words are placed.

If the TCAM 15 matches on an incoming address 22, access to the main memory (not shown) may be turned off and incoming 23 or outgoing 28 data will be redirected to or from the redundant memory 18 using multiplexers 23, 28. The incoming address 22 is remapped from an address in the main memory (not shown) to an address in the redundant memory 18.

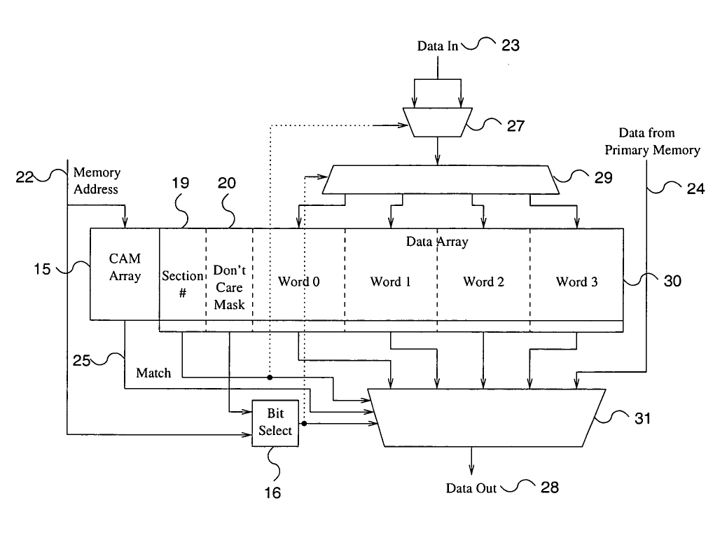

FIG. 4 is a block diagram illustrating a TCAM-based associative redundancy method for a semiconductor memory according to a alternative present embodiment of the invention. This embodiment removes the requirement for an adder 17 and separate redundant memory 18 by placing four (or another number) of redundant data words 30 in the associated data array. This is a faster and simpler design than the first embodiment, but suffers from a waste of redundant data words for small faults and the use of many more TCAM entries for larger faults.

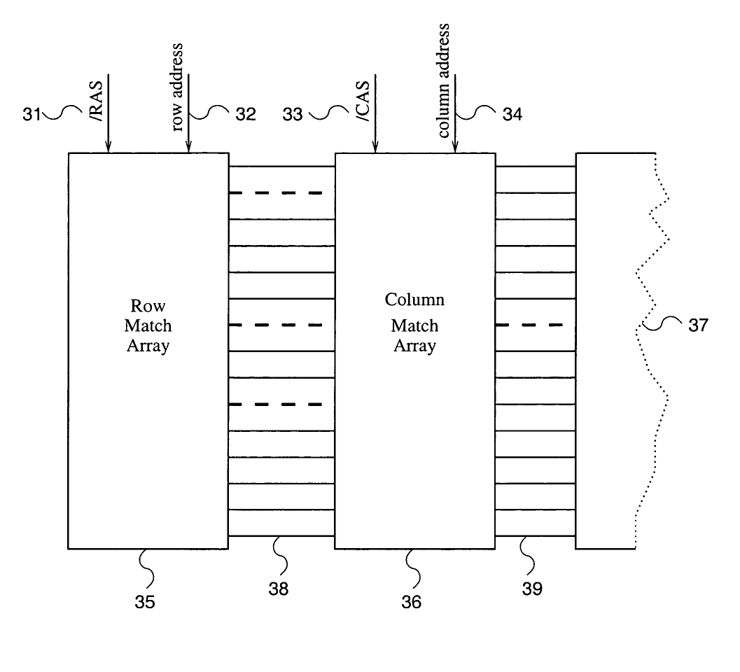

FIG. 5 is a block diagram illustrating a method to split the compare device (CAM) into two parts; one for the row component 32 and the other for the column component 34 of an incoming address. This reduce power consumption. This allows correct operation when there are slow and quick changing parts of an address, such as page mode or double data-rate (DDR) operation in current DRAMs where the column component of the address may change several times for each row component. In this embodiment, the first match array 35 compares the row component of the address. Only those entries which matched 38 (dashed lines) will have their corresponding columns compared in the column match array 36. In a pre-charge and evaluate type comparison device, power consumption is reduced by only pre-charging much fewer entries.

1. A method of remapping programmable sized regions of memory for the purpose of defect tolerance or fault tolerance.

2. The remapping method of claim 1, wherein the adjustable sized regions are rectangular.

3. The remapping method of claim 2, wherein some memory access requests are redirected to a secondary memory.

4. The remapping method of claim 3, wherein the remapping is selected when the memory address matches by belonging to one or more regions of addresses, which are stored in a database.

5. The remapping method of claim 4, wherein a ternary content addressable memory is used to store the database or perform the matching of addresses.

6. The remapping method of claim 5, wherein rows and columns of the memory are addressed in Gray-coded sequence.

7. A redundancy apparatus comprising ternary content addressable memory and memory where the ternary content addressable memory processes the address of all incoming memory access requests.

8. The redundancy apparatus of claim 7, further including means to access memory in a corresponding memory array.

9. The redundancy apparatus of claim 8, wherein the accessed data contains a bit mask and a base address to a redundant memory.

10. The redundancy apparatus of claim 9, further including means to produce an address offset from the mask and incoming address.

11. The redundancy apparatus of claim 10, further including means to add the offset and base address to produce an address to a redundant memory.

12. The redundancy apparatus of claim 11, wherein a redundant memory location may be accessed in place of the main memory.

13. The redundancy apparatus of claim 8, wherein the accessed data contains a bit mask and memory storage locations.

14. The redundancy apparatus of claim 13, wherein the bit mask and incoming address are used to produce an offset of not more bits than log₂ (storage locations).

15. The redundancy apparatus of claim 14, wherein the offset is used to access the correct storage location is place of main memory.

16. The remapping method of claim 6, wherein once an incoming memory access request is matched in the ternary content addressable memory, a corresponding location of the memory array is accessed.

17. The redundancy apparatus of claim 10, further including means to combine the offset and base address to produce an address to a redundant memory.

18. The redundancy apparatus of claim 11, further including means to multiplex between the read data from the primary memory and the read data from the redundant memory to produce the final read result of the apparatus.
